(19) United States
(12) Patent Application Publication
(10) Pub. No.: US 2001/0000421 A1
(43) Pub. Date: Apr. 26, 2001

(54) Cold cathode fluorescent display

(76) Inventor: Xiaoqin Ge, San Jose, CA (US)

Correspondence Address: James S. Hsue, Skjerven Morrill MacPherson LLP, Suite 700, 25 Metro Drive, San Jose, CA, 95110, US

(21) Appl. No.: 09/733,706

(22) Filed: Dec. 8, 2000

Related U.S. Application Data
(63) Continuation of application No. 09/183,763, filed on Oct. 30, 1998.
Application No. 09/183,763 is a continuation of application No. 08/532,077, filed on Sep. 22, 1995, now Pat. No. 5,834,889.

(51) Int. Cl. H01J 17/20

(52) U.S. Cl. 313/493; 313/113; 313/573; 313/317

(57) ABSTRACT

A monochromic, multi-color and full-color cold cathode fluorescent display (CFD), comprises of some shaped white or multi-color or red, green blue color cold cathode fluorescent lamps (CCFL), reflector, base plate, temperature control means, luminance and contrast enhancement face plate, shades and its driving electronics. CFD is a large screen display device which has high luminance, high efficiency, long lifetime, high contrast and excellent color. CFD can be used for both outdoor and indoor applications even at direct sunlight, to display a character, or graphic and video image.

### BACKGROUND OF THE INVENTION

1. 1. Field of the Invention

2. This invention relates in general to a cold cathode fluorescent display (CFD) and in particular, to a high luminance, high efficiency, long lifetime, monochrome or multi-color or full-color ultra-large screen display device, which can display character, graphic and video images for both indoor and outdoor applications.

3. 2. Description of the Prior Art

4. The major prior technologies for ultra-large screen display are as follows:

5. A. Incandescent lamp display:

6. This display screen consists of a lot of incandescent lamps. The white lamps are always used for displaying a white and black character and graphic. The color incandescent lamps, which use red, green, and blue (R, G, B) color glass bubbles, are used for displaying multi-color or full-color character, graphic and image. An incandescent lamp display has been widely used for an outdoor character and graphic displays and possesses certain advantages such as high luminance, functionable at direct sunlight with shade and low cost of lamps. Nevertheless, this technology suffers from the following disadvantages: low luminous efficiency (i.e., white lamp about 10 lm/W; R, G, B<⅓of white);

7. high power consumption; poor reliability, unexpected lamp failure; short lifetime; expensive maintenance cost; long response time and is unsuitable for video display.

8. B. LED:

9. LED has been widely used for indoor large screen and ultra-large screen displays, to display a multi-color and full-color character, graphic and video image. This display is able to generate high luminance for indoor applications and can maintain a long operation lifetime at indoor display luminance level. The disadvantages of LED, however, are as follows: low luminous efficiency and high power consumption especially for the ultra-large screen display; low luminance for outdoor applications especially when a wide viewing angle is required or at direct sunlight; is expensive, especially for an ultra-large screen display because of of the need of a lot of LEDs; and has a lower lifetime at a high luminance level.

10. C. CRT:

11. CRT includes Flood-Beam CRT (e.g., Japan Display '92, p. 285, 1992), and matrix flat CRT (e.g., Sony's Jumbotron as disclosed in U.S. Pat. No. 5,191,259) and Mitsubishi's matrix flat CRT (e.g., SID '89 Digest, p. 102, 1989). The CRT display is generally known for its ability to produce good color compatible with color CRT. The disadvantages of CRT are as follows: low luminance for outdoor applications; low contrast at high ambient illumination operating condition; short lifetime at high luminance operating condition; expensive display device due to complex structure and high anode voltage of about 10 kv.

12. D. Hot Cathode Fluorescent Display:

13. Hot cathode fluorescent technology has been used in a display system called “Skypix” (SID '91 Digest. p. 577, 1991) which is able to generate a high luminance of about 5000 cd/m² and can be operated at direct sunlight. The disadvantages of this system are: low luminous efficiency due to hot cathode and short gas discharge arc length; very high power consumption and short lifetime because of the hot cathode and too many switching times for video display.

14. At present, the incandescent lamps are commonly used for an outdoor character and graphic display.

15. The matrix flat CRT, including food beam CRT and matrix CRT, is the most common display for an outdoor video display. Neither of these two technologies presents a display system which can be used in both indoor and outdoor applications possessing unique features overcoming all or substantially all of the disadvantages described above.

### SUMMARY OF THE INVENTION

16. The present invention has been made in view of the foregoing disadvantages of the prior art.

17. Accordingly, it is an object of the present invention to provide a very high luminance large screen and ultra-large screen display using a shaped cold cathode fluorescent lamp (“CCFL”) with a special reflector and luminance enhancement face plate etc. It can be used for both indoor and outdoor applications even at direct sunlight. The dot luminance of the character and graphic display can be up to 15,000 cd/m² or more. The area average luminance of the full-color image can be up to 5000 cd/m² or more.

18. It is another object of the present invention to provide long lifetime large screen and ultra-large screen displays. The lifetime can be up to 20,000 hours or more at high luminance operating conditions.

19. It is one more object of the present invention to provide high luminous efficiency, low power consumption large screen and ultra-large screen displays. The luminance efficiency can be up to 30 lm/W or more.

20. It is a further object of the invention to provide a high contrast large screen and ultra-large screen display with the appropriate shades, black base plate and luminance and contrast enhancement face plate.

21. It is still a further object of the present invention to provide good temperature characteristics in large screen and ultra-large screen displays with a temperature control means. The CFD of the present invention can be used for both indoor and outdoor applications, and any ambient temperature condition,

22. In accordance with the present invention, a CFD is provided including some shaped R, G, B CCFLs, and R, G, B filters, reflectors, a base plate, a luminance and contrast enhancement face plate, a temperature control means, and its driving electronics to control the lighting period or lamp current or ON/OFF of CCFLs according to the image signal, and to control the luminance of CCFLs to display the character, graphic and image with monochrome, multi-color or full-color.

### BRIEF DESCRIPTION OF THE DRAWINGS

23. Other objects and many of the attendant advantages of the present invention will be readily appreciated as the same becomes better understood by reference to the following detailed description when considered in connection with the accompanying drawings, wherein:

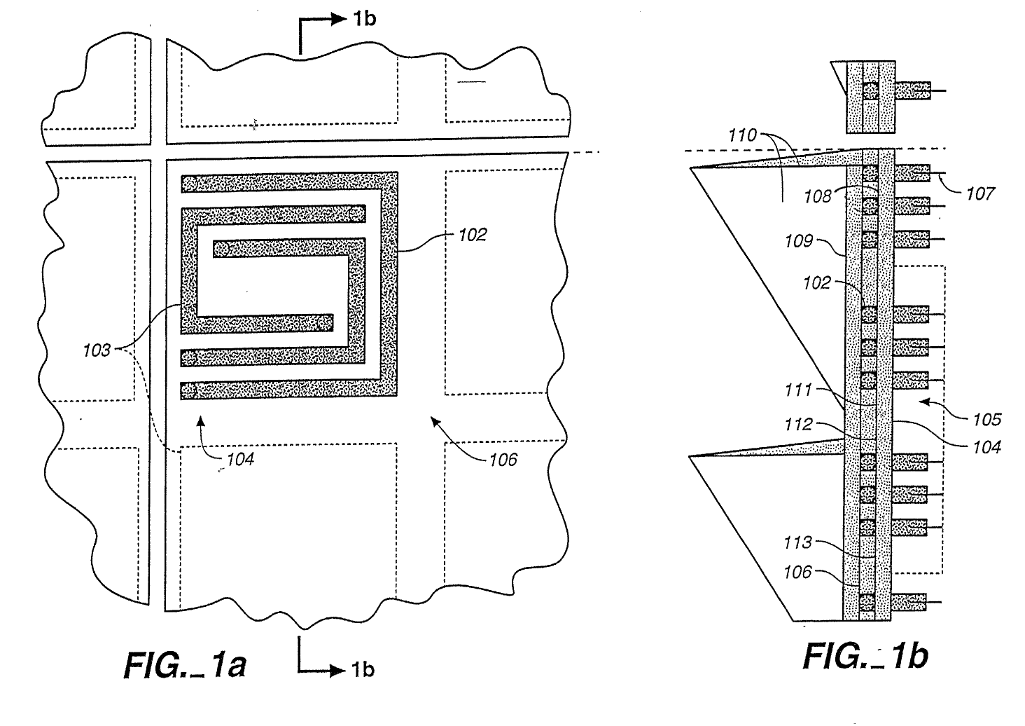

24. FIGS. 1(a) and 1(b) show a mosaic CCFL assembly type CFD with FIG. 1(a) being a partial top view of the mosaic CFD to illustrate the preferred embodiment of the invention and FIG. 1(b) being a partial side cross-sectional view of the device in FIG. 1(a).

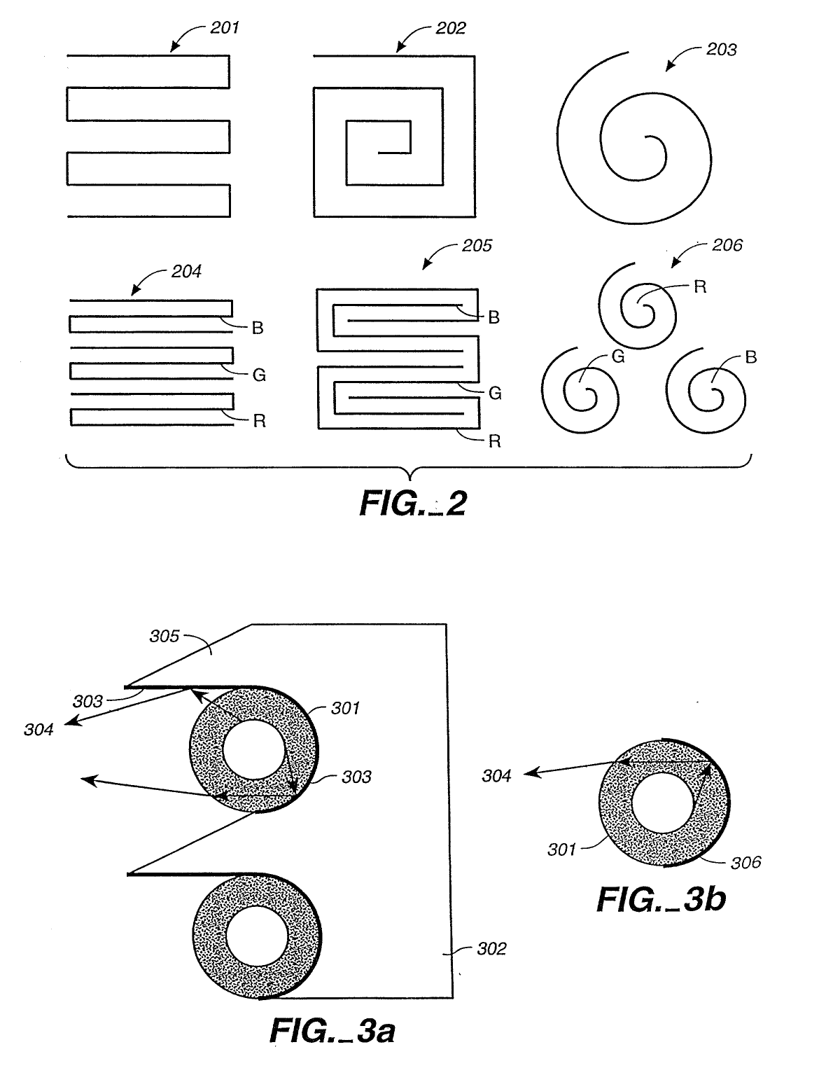

25. FIG. 2 shows some shape examples of CCFL.

26. FIGS. 3(a) and 3(b) are partially cross-sectional views of two types of reflectors and the CCFLs.

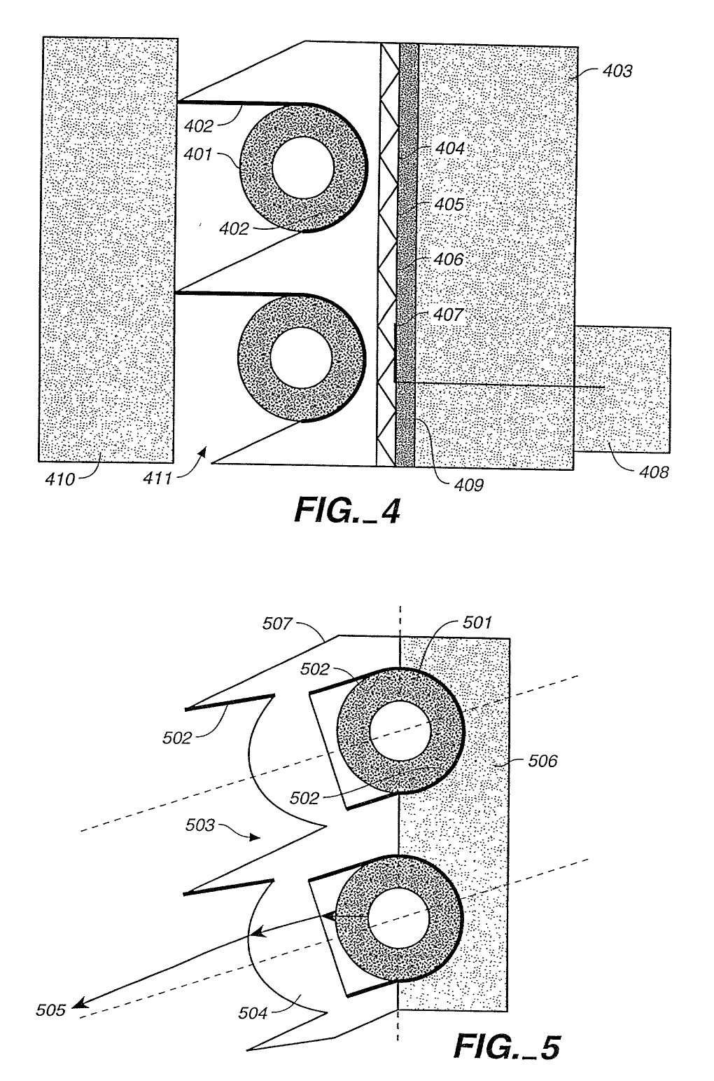

27. FIG. 4 is an embodiment of the heating and temperature control means.

28. FIG. 5 is a cross-sectional view of an embodiment of the luminance and contrast enhancement face plate.

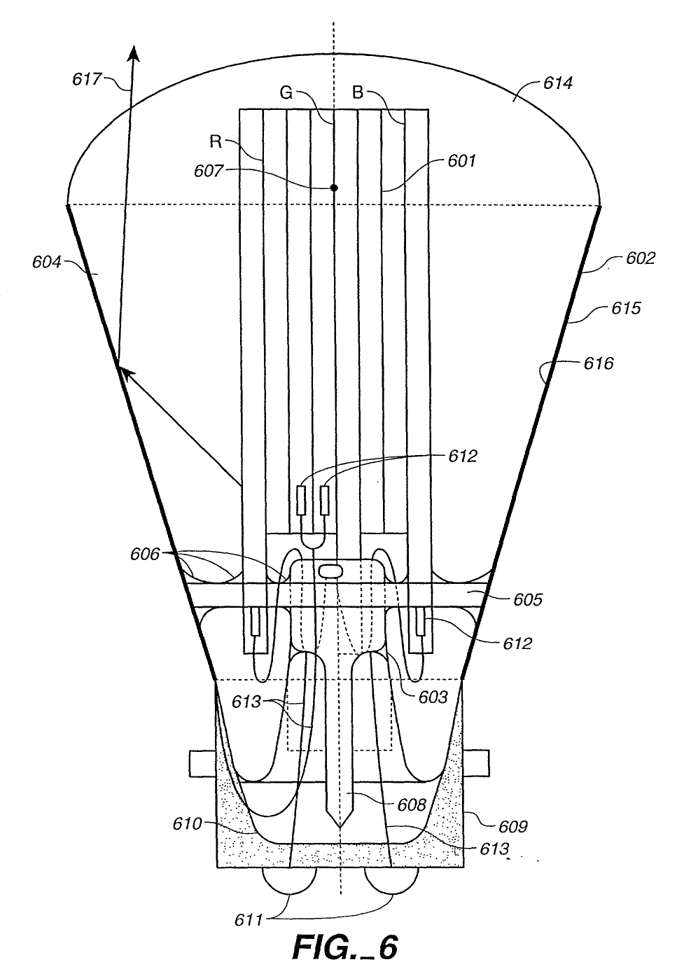

29. FIG. 6 shows the structure of a luminescent element of a CCFL lamp type CFD.

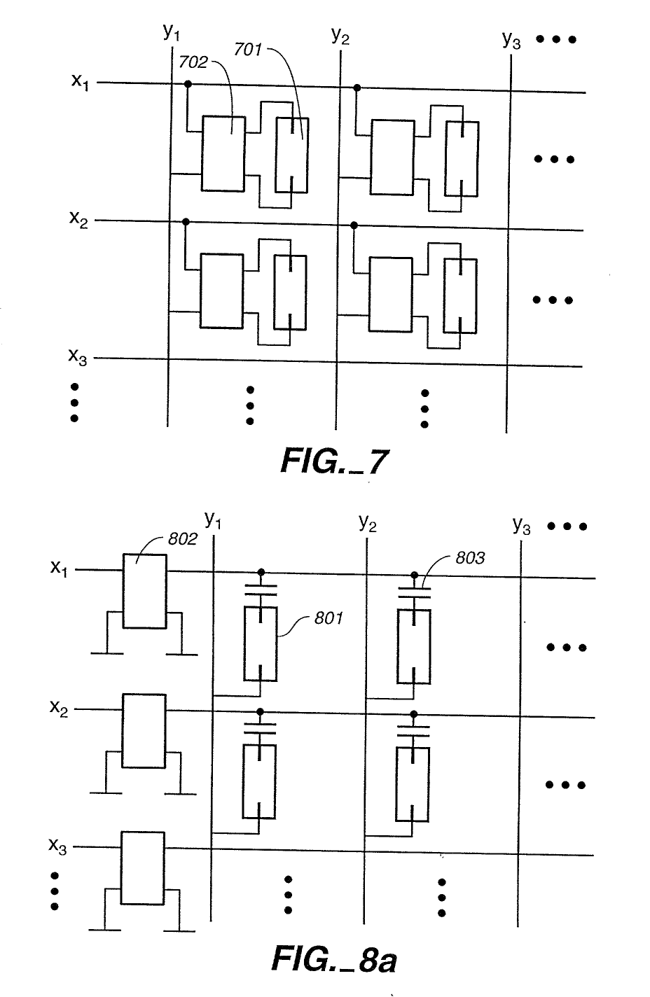

30. FIG. 7 is a schematic driving circuit diagram of CFD.

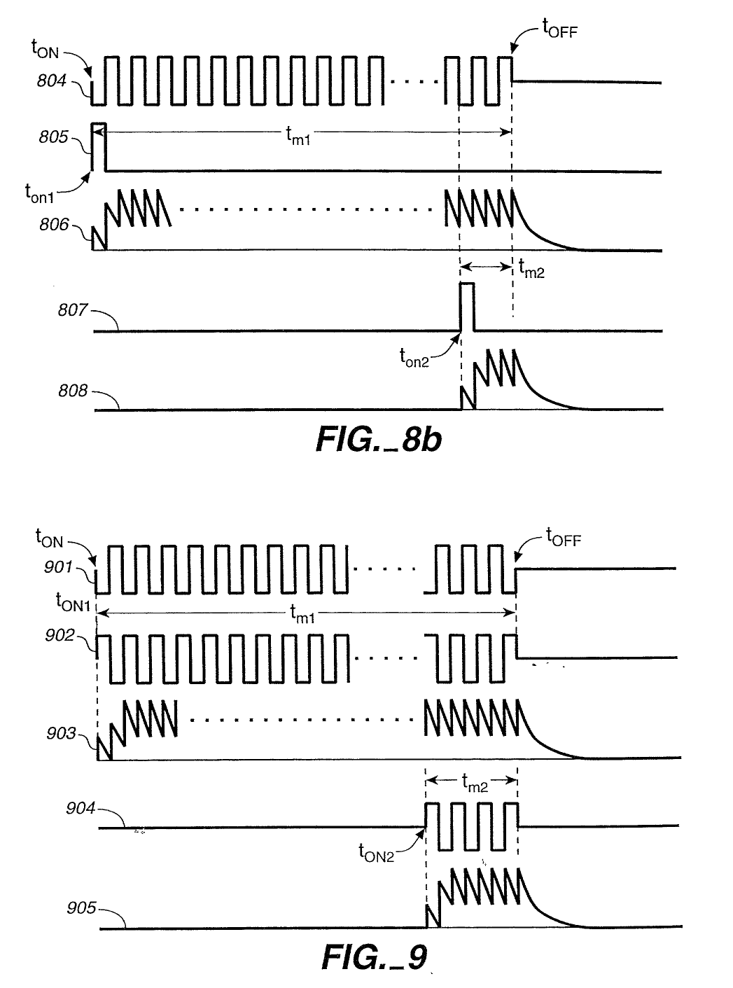

31. FIG. 8(a) is another schematic driving circuit diagram of CFD.

32. FIG. 8(b) is a timing diagram to illustrate the operation of the circuit of FIG. 8(a).

33. FIG. 9 is a timing diagram to illustrate another operating method of the circuit of FIG. 8(a).

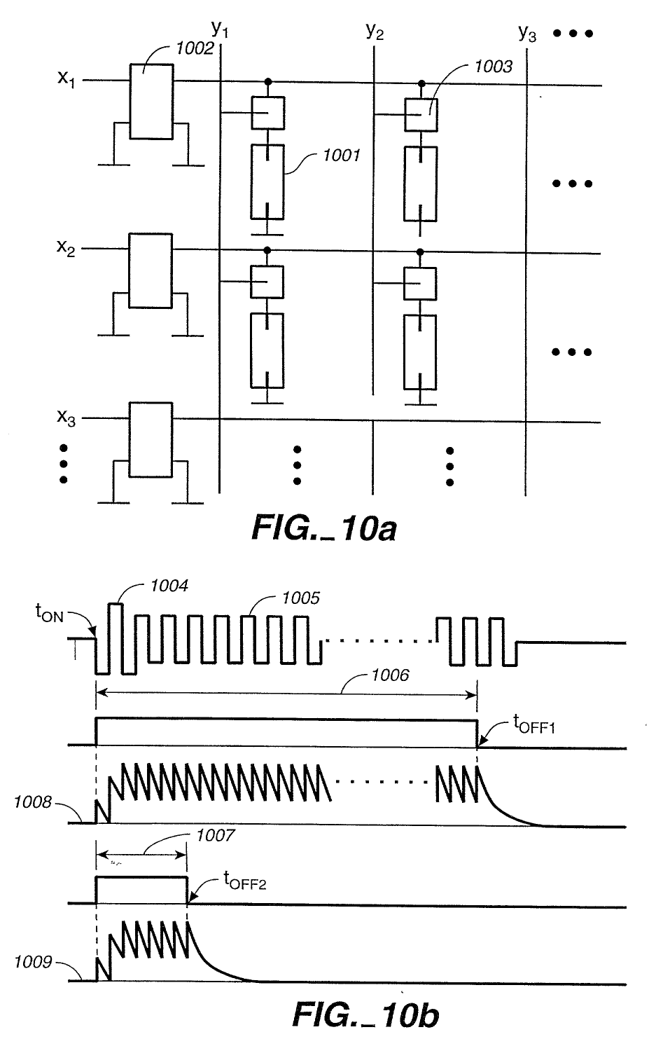

34. FIG. 10(a) is an alternative schematic driving circuit diagram of CFD.

35. FIG. 10(b) is a timing diagram to illustrate the operation of the circuit of FIG. 10(a).

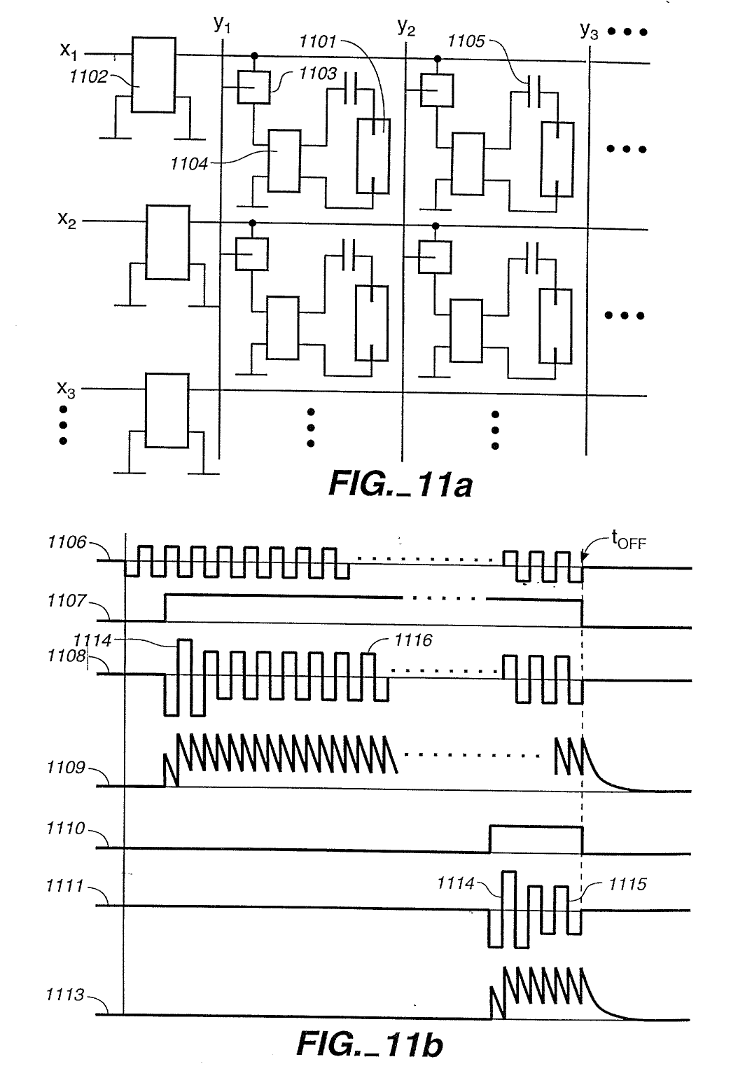

36. FIG. 11(a) is a different schematic driving circuit diagram of CFD.

37. FIG. 11(b) is a timing diagram to illustrate the operation of the circuit of FIG. 11(a).

### DETAILED DESCRIPTION OF THE PREFERRED EMBODIMENTS

38. Now, a CFD according to the present invention will be described with reference to the accompanying drawings.

39. The CFD of the present invention has two types: CCFL assembly type and CCFL lamp type.

40. The CFD of the present invention can be a single piece structure or a mosaic structure. For the ultra-large screen CFD, it is always made in a mosaic type, i.e., the display screen is assembled by some mosaic tiles.

41. FIGS. 1(a) and 1(b) show a mosaic CCFL assembly type CDF wherein FIG. 1(a) shows a partial top view of a preferred embodiment of the mosaic CFD provided by the present invention and FIG. 1(b) further shows a partial side-view of FIG. 1(a). 101 is a partially sectional view of four (4) mosaic CFD tiles. The mosaic CFD tile includes shaped CCFLs 102, which can emit white or R, G and B light. FIG. 1(a) is an embodiment of R, G and B full-color CFD. 103 is a pixel which comprises three shaped R, G and B color CCFLs. Generally, although not shown here, one or more pixels are combined together to form a module and one or more modules combined together to form a display screen to display full-color character, graphic and video image. The R, G and B color CCFLs may be respectively equipped with R, G and B filters whose functions are to absorb the variegated light emitted from gas discharge of the CCFLs to increase color purity, to improve the quality of the display images and to increase the contrast of the display image by absorbing the ambient incident light. Alternatively, the R, G and B CCFLs are made of R, G and B color glass tubes to absorb the variegated light emitted from gas discharge of CCFLs, to increase the color purity and to absorb the ambient incident light to increase the contrast of display image.

42. The shape of CCFL can be a “U” shape, serpentine shape, circular shape or other shapes. For the white or monochromic display, the pixels can be one shaped CCFL or two or more different color CCFLs. 104 is the base plate for the installation of the CCFLs 102, its driver 105 and other parts are described below. 106 is a black non-reflective surface between CCFLs 102 and the base plate 104 to absorb the ambient incident light and to increase the contrast of the display image. 107 are the electrode terminals of CCFLs 102, said electrode terminals 107 are bended towards the back of the base plate 104 and are connected to drivers 105. 108 is a reflector. 109 is a luminance and contrast enhancement face plate. 110 is the black shade to absorb the ambient incident light, including sunlight, to increase the contrast of the display image. 111 is a heating and temperature control means seated between CCFL 102 and base plate 104, and close to CCFL 102 to make the CCFL operating at an optimum temperature, e.g., 30° C. to 75° C., to guarantee the luminance and color uniformity of the display image and to get high luminance, high luminance efficiency, and to quickly start the display system at any ambient temperature. The heating and temperature control means 111 has a heat conductive plate 112. One mosaic tile may have one or several pieces of the heat conductive plate 112 to ensure that all CCFLs are operated at the same optimum temperature. Between the heating and temperature control means 111 and base plate 104, there is a heat preservation layer 113 to decrease the heat loss and to decrease the power consumption.

43. FIG. 2 shows some examples of the possible shapes of the shaped CCFL 102. The shapes of 201, 202, and 203 are for the white or monochromic display, and 204, 205, and 206 are for multi-color and full-color displays.

44. FIGS. 3(a) and (b) are the cross-sectional view of two kinds of reflectors and CCFL for the CCFL assembly type CFD as shown in FIG. 1. 301 is the CCFL. 302 is the base plate. 303 is the reflector which is made of high reflectance layer, e.g., Al or Ag or other alloy film, or a high reflectance diffusing surface, e.g., white paint. The reflector 303 is used for reflecting the light emitted from the CCFL forward to viewers shown as 304. 305 are a plurality of small shades seated between CCFLs to absorb the ambient incident light to increase the contrast of the display image. In FIG. 3b, the reflector 306 is made of a high reflectance film, e.g., Al, Ag or alloy film, deposited on the back surface of the CCFL.

45. FIG. 4 shows an embodiment of the heating and temperature control means. 401 is a CCFL. 402 is a reflector. 403 is the base plate. 404 is a heating means, e.g., it is made of an electric heating wire 405 or an electric heating film. 406 is a heat conductive plates and each mosaic tile has one or more heat conductive plate 106 to ensure that all CCFLs are operated at the same optimum temperature. 407 is a temperature sensor and 408 an automatic temperature control circuit. 409 is a heat insulating layer whose function is to decrease the heat loss and decrease the power consumption. 410 is a luminance and contrast enhancement face plate. The chamber between the face plate 410 and heat insulating layer 409 is a heat preservation chamber 411. The temperature of the chamber is controlled at an optimum operating temperature of CCFL, e.g., 30° C. to 75° C.

46. The said heating means 404 can simply be a heated air flow. The heat air flows through the whole screen between the face plate and the base plate. Some temperature sensors and control circuits are used to detect and control the temperature of the CCFL chamber.

47. FIG. 5 is a cross-section view of an embodiment of the luminance and contrast enhancement face plate. 501 is the CCFL. 502 is the reflector. 503 is the luminance and contrast enhancement face plate, which consists of a cylinder lens or lens array 504 and the small shades 507. The optical axis of the lens is directed towards the viewers. The light emitted from the CCFL can effectively go through the reflector 502 and becomes focused on the lens 504 to a viewer 505 and thus, increase the luminance of the display image and the effective luminous efficiency. 506 is the base plate. 507 is a small shade seated at the top of the CCFL to absorb ambient incident light, including sunlight, to increase the contrast of the display image.

48. FIG. 6 shows luminescent elements of a CCFL lamp type CFD. 601 is the CCFL. For monochrome or white/black displays, 601 is at least one shaped white or monochrome CCFL. For the multi-color display, 601 is at least one group multi-color CCFL. For the full-color display, 601 is at least one group of R, G, B three color CCFL as shown in FIG. 6. 602 is a glass tube. 603 is a lamp base which is sealed within the glass tube 602 to form a vacuum chamber 604. 605 is a base plate on which the CCFLs are fixed. The base plate 605 is fixed on the lamp base 603 and its two ends are fixedly connected to the internal surface of the glass tube 602. To obtain a good fixing effect, a vacuum adhesive 606 such as ceramic adhesive is applied between/among the base plate 605, the lamp base 603 and the CCFLs. If the CCFL is more than one piece between the CCFLs, these CCFLs are also fixed to each other by an vacuum adhesive 607. 608 is an exhaustion tube for exhausting the gas in the chamber 604. 609 is a lamp head which is fixed to the lamp base by a fixing adhesive 610. 611 are connectors of the lamp. 612 are electrodes of the CCFLs which are connected to the connector 611 and the lamp head 609 through leads 613. The glass tube 602 can be a diffusing glass tube to obtain a diffusing light. Alternatively, the glass tube 602 as shown in FIG. 6, the glass tube 602 has a front face 614 and a backside 615. The front face 614 is a transparent or a diffusing spherical surface and the backside 615 is a cone shape or a near cone shape tube. On the internal surface of the backside 615 of the glass tube, there is a reflective film 616, e.g., an Al, Ag, or alloy thin film, to reflect the light and to increase the luminance of the lamp shown as 617. The vacuum chamber 604 can reduce the heat loss of the CCFL and hence increase the efficiency of the CCFL. In addition, the vacuum chamber 604 can also eliminate any undesirable effects caused by the ambient temperature to the characteristics of the CCFL. The base plate 605 is a high reflective plate to reflect the light and to increase the luminance of the CFD. Some of the CCFL lamps shown in FIG. 6 can be used for making the monochromic, multi-color, full-color display system to display a character, graphic or video images. The CCFL lamps can also be used for the purposes of illumination.

49. Referring now to FIG. 7, the driving circuit of CFD is schematically diagramed. 701 are the CCFLs. 702 are DC/AC converters which change the DC input voltage to a high voltage and high frequency (e.g., tens kHz,) AC voltage to drive the CCFL. The symbols x₁, x₂ . . . are scanning lines. The symbols y₁, y₂ . . . are column data electrodes. One DC/AC converter 702 drive one CCFL 701. To control the period of input voltage of the DC/AC converter 702 according to an image signal, the luminance of the CCFL can be controlled and the character, graphic and the image can be displayed.

50. The CFD as illustrated in FIG. 7 will need a lot of DC/AC converters to drive its CCFLs. In order to reduce the number of DC/AC converters and to reduce the cost of the display system, a method which uses one DC/AC converter driving one line of CCFL or one group of CCFL can be adopted as shown in FIG. 8(a). FIG. 8(b) is a timing diagram to further illustrate the operation of the circuit of FIG. 8(a). 801 are the CCFLs. 802 are the DC/AC converters. 803 are coupled capacitors. The symbols x₁, x₂ . . . are scanning lines. The symbols y₁, y₂ . . . are column data electrodes. When one scanning line, e.g., x₁, is addressed (FIG. 8a, t_{ON}), the related DC/AC converter is turned ON to output a sustained AC voltage shown as 804. This sustained voltage is lower than the starting voltage of the CCFL, and cannot start the CCFLs of this line, but can sustain lighting after CCFL started. Because the starting voltage of CCFL is much larger than the sustained voltage, when the column date electrode (y₁, y₂, . . ) is at 0 v, the related CCFL cannot be started and will stay at the OFF state. When the column date electrode supplies an anti-phase trigger voltage, the related CCFL will be started. The CCFL will light until the related DC/AC converter is turned OFF as shown in FIG. 8(b) as t_{OFF}. The lighting period tₘ according to the image signal can be controlled to modulate the luminance of CCFL and to display character, graphic, and image with monochrome or multi-color or full-color. For example, 805 is for a high luminance 806, the lighting period is tₘ₁, (=t_{OFF}−tₒₙ₁), and 807 is for a lower luminance 808, the lighting period is tₘ₂ (−t_{OFF}−tₒₙ₂) and so on.

51. FIG. 9 shows a different operating method than the circuit shown in FIG. 8a. 901 is the same as 804 as shown in FIG. 8(b) for line scanning. 902 and 904 are column data voltage, which have an anti-phase with the scanning voltage 901. When a CCFL is applied to the scanning voltage 901 and the signal voltage 902 at the same time, the total voltage applied to the CCFL will be larger than the starting voltage of the CCFL which will light the CCFL in this period. The ON time tₘ₁ and tₘ₂, i.e., lighting period, depend on image signals. Different tₘ have different lighting periods shown as 903 and 905, i.e., different luminance, to display a character, graphic and image.

52. FIG. 10(a) is yet another schematic diagram for the driving circuit of CFD. The symbols x₁, x₂ . . . are the scanning lines. The symbols y₁, y₂ . . . are the column data electrodes. 1001 are the CCFLs. 1002 are the DC/AC converters. 1003 are AC voltage switches. One line ofthe CCFL or one group of CCFLs has one DC/AC converter 1002. When the switch 1003 is turned ON according to the image signal, the related CCFL will be lighted, and the character, graphic and image can be displayed. In this case, because the starting voltage of CCFL is larger than the sustained voltage, all CCFLs in the same line or same group should start at the same time as shown in FIG. 10(b) as t_{On}. At this time, the related DC/AC converter will be turned ON to output a larger voltage 1004, which can start the CCFL. Consequently, all the CCFLs connected with this DC/AC converter are started at this time if the related switch is turned ON. After the CCFL started, the DC/AC converter will output a lower sustained voltage 1005 to sustain the CCFL lighting. The turned OFF time t_{OFF}, e.g., T_{off1}, and T_{off2}, can obtain a different lighting period, e.g., 1006 and 1007, different luminance 1008 and 1009 can be obtained to display the character, graphic and image.

53. FIG. 11(a) shows a low AC voltage switch driving circuit. The symbols x₁, x₂ . . . are scanning lines. The symbols y₁, y₂ . . . are column data electrodes. 1101 are the CCFLs. 1102 are DC/AC converters, which outputs a low AC voltage, e.g., several to ten volts and tens kHz. One line of CCFL or one group of CCFLs has one DC/AC converter. 1103 are low AC voltage switches. 1104 are transformers from which the low AC voltage can be changed to a high AC voltage. 1105 are coupling capacitors. The driving timing diagram is shown in FIG. 11(b). 1106 is the low AC voltage output from the DC/AC converter when the line is addressed. 1107 and 1110 are the AC switch control voltages, their widths are dependent on the image signals. 1108 and 1111 are the high AC voltage output transformers. 1109 and 1113 are the light waveforms emitted from the CCFLs. When an AC switch is turned ON, the related transformer will output a higher voltage 1114 to starting the related CCFL. After the CCFL is started, the transformer output a lower sustained voltage 1115 to sustain the CCFL lighting. When the DC/AC converter 1102 is turned OFF, shown as t_{OFF}, all the addressed CCFLs are turned OFF. To control the ON time of the AC switch according to an image signal, the luminance of the CCFL can be modulated to display the character, graphic and image.

What is claimed is:

1. A cold cathode fluorescent display (CFD), comprising:
one or more than one shaped cold cathode fluorescent lamps (CCFLs);
one or more than one reflectors seated at the back of the CCFLs or on the back surface of the CCFLs to reflect and forward the light emitted from the CCFLs to viewers and to increase the luminance of display images;
a base plate for the installation of the CCFLs and other parts;
a heating and temperature control means seated between the CCFLs and the base plate to make the CCFLs operating at an optimum temperature, to guarantee the luminance and color uniformity of display image, to get a high luminous efficiency and to start fast the display system at any ambient temperature;
a luminance and contrast enhancement face plate seated at the front of the CCFLs, said face plate is capable of absorbing the ambient incident light, focusing and forwarding the light emitted from the CCFL forward to viewers and increasing the luminance of display images;
one or more than one shades around the CCFLs to absorb the ambient incident light to enhance the contrast of display images;
driving electronics for CCFLs;
means for applying the appropriate operating voltage to control the lighting period or the lamp current according to the image signals so as to control the luminance of CCFLs and to display the character, graphic or video image.

2. The device of claim 1 wherein said CCFLs are white CCFLs or monochromatic CCFLs to display white/black or monochromic character, graphic and image.

3. The device of claim 1 wherein said CCFLs are different color CCFLs to display multi-color character, graphic and image.

4. The device of claim 1 wherein said CCFLs are red, green, and blue (R, G and B) three primary color CCFLs.

5. The device of claim 4 wherein one or more R, G and B color CCFLs are combined to form a pixel and one or more pixels together to form a module and one or more modules together to form a display screen to display full-color character, graphic and video image.

6. The device of claim 5 wherein said R, G and B color CCFLs have R, G and B filters respectively to absorb the variegated light emitted from gas discharge of the CCFLs to increase the purity of color and improve the quality of color display image while increasing the contrast of display image by absorbing the ambient incident light.

7. The device of claim 5 wherein said R, G, B CCFLs are made of R, G, B color glass tubes to absorb the variegated light emitted from gas discharge of CCFLs to increase the color purity and absorb the ambient incident light to increase the contrast of display image.

8. The device of claim 1 wherein said shaped CCFLs may be an “U” shape, a serpentine, a circular or other shapes to form a display pixel or dot.

9. The device of claim 1 wherein said reflector is a high reflectance thin film, e.g., an Ag, Al or other alloy thin film.

10. The device of claim 1 wherein said reflector is a high reflectance diffusing wall, e.g., a white paint.

11. The device of claim 1 wherein said heating and temperature control means comprise a heating element, e.g., an electrical heating wire or film, a temperature sensor, an automatic control circuit and a heat conductive plate, e.g., an Al or alloy plate and wherein the heating element is seated on the heat conductive plate to keep the CCFLs and the whole screen at the same temperature.

12. The device of claim 1 wherein there is a heat insulation means between said heating and temperature control means and the base plate to decrease power consumption of said heating and temperature control means.

13. The device of claim 1 wherein said heating and temperature control means is eliminated for an indoor display application.

14. The device of claim 1 wherein said base plate is a black plate to absorb the ambient incident light and to increase the contrast of display image.

15. The device of claim 1 wherein said base plate is one piece plate for a smaller display screen, but one or more of the base plates are required to form a tile from which one or more of it are assembled to form a larger screen ultra-large screen display.

16. The device of claim 1 wherein said luminance and contrast enhancement face plate further comprises a focus means, e.g., a series of cylinder lenses or a lens array, to focus and forward the light from CCFL to the direction of an viewer and to increase the luminance of display image.

17. The device of claim 16 further comprises some small shades seated on the focus means to absorb the ambient incident light and to increase the contrast of display image.

18. The device of claim 16 wherein said focus means can change the direction of light emitted from CCFL so as to forward said light to the direction of an viewer, e.g., the optical axis of the focus means is arranged to the direction of an viewer.

19. The device of claim 1 wherein said shades are black and non-reflection shades seated around the display pixels to absorb the ambient incident light, to increase contrast of display image.

20. A monochromic Cold Cathode Fluorescent Display (CFD), comprising:
at least one shaped monochromic or white CCFL having at least one electrode;
a glass tube;
a base plate to fix the CCFL;
a lamp base for fixing onto it said glass tube, said base plate and said CCFL, said lamp base has connectors to which the electrode of the CCFL is connected; and
said glass tube is a vacuum chamber within which said CCFL is sealed so as to decrease the heat loss of CCFL, to increase the luminous efficiency and to eliminate the effect of the ambient temperature of the CFD.

21. The device of claim 20 wherein said glass tube is a diffusing glass tube.

22. The device of claim 20 wherein the front face of said glass tube is a transparent spherical surface and the backside of said glass tube is a cone shape or a near cone shape tube and there is a high reflective layer, e.g., an Al, Ag or alloy thin film, on the internal surface of said cone tube to reflect the light and to increase the luminance of CFD.

23. A multi-color or full-color CFD, comprising:
at least one group of different color or R, G and B three primary color shaped CCFLs having at least one group of electrodes;
a glass tube;
a base plate to fix the CCFLs;
a lamp base for fixing onto it said glass tube, said base plate and said CCFLs' said lamp base has connectors to which the electrodes of the CCFLs are connected; and
said glass tube is a vacuum chamber within which said CCFLs are sealed so as to decrease the heat loss of said CCFLs, to enhance the luminous efficiency can be increased and to eliminate the effect of the ambient temperature to the CFD.

24. The device of claim 23 wherein said glass tube is a diffusing glass tube.

25. The device of claim 23 wherein the front face of said glass tube is a transparent spherical surface and the backside of said glass tube is a cone shape or a near cone shape tube and there is a high reflective layer, e.g., an Al, Ag or alloy thin film, on the internal surface of said cone tube to reflect the light and to increase the luminance of CFD.

26. The device of claim 23 wherein the front face of said glass tube is a diffusing spherical surface.

27. The device of claim 23 wherein the base plate is a high reflectance plate to reflect the light and to increase the luminance of the CFD.

28. A driving method for CFD, comprising:
one DC/AC converter for one CCFL wherein said DC/AC converter can convert an input DC voltage to a high voltage and high frequency. e.g., tens kHz, Ac voltage to drive CCFL so as to control the lighting period or lamp current of the CCFL to change the luminance and to display the character, graphic and image.

29. A driving method for CFD, comprising:
one line or one group of CCFLs are driven by one DC/AC converter wherein said DC/AC converter outputs a sustained voltage and said sustained voltage is lower than the starting voltage of CCFLs so that when the column data electrode is at 0 v, the related CCFLs can not be started and when the column data electrode is supplied a trigger voltage, the related CCFLs will be started to sustain the lighting state ofthe CCFLs until DC/AC converter is OFF so as to control the lighting period and the luminance of CCFL to display the character, graphic and image can be displayed.

30. A driving method for CFD, comprising:
one line or one group of CCFLs are driven by one DC/AC converter wherein each of the CCFLs has a high AC voltage switch connected to the DC/AC converter which is controlled by a column data signal for the control of the luminance of the CCFLs so that when said line or said group of CCFLs is addressed, the related DC/AC converter is turned ON which turns on all switches of this line or group beyond the OFF CCFL and the DC/AC converter outputs a high starting AC voltage to start all the CCFLs when the switches are ON according to the image signal so as to modulate the brightness of the CCFLs and to display the character, graphic and image can be displayed.

31. A driving method for CFD, comprising:
one line or one group of CCFLs are driven by one DC/AC converter which outputs a low AC voltage, e.g., several to tens volts and tens kHz wherein each of the CCFLs has a low AC voltage switch and a transformer so that when the switch is turned ON, the related Dc/AC converter outputs a high AC voltage to start the related CCFLs and after the CCFLs are started, the transformer outputs a sustained voltage to sustain the CCFL lighting and when the DC/AC converter is turned OFF, all the related CCFLs are turned OFF so as to control the lighting period and modulate the brightness ofthe CCFLs by controlling the turn ON time of the switch according to the video signal and to display the character, graphic and image.
